(19) United States
(12) Patent Application Publication
(10) Pub. No.: US 2017/0266864 A1
(43) Pub. Date: Sep. 21, 2017

(54) DEVICE FOR BENDING A PROFILED WORKPIECE

(71) Applicants: Rudolf STONAWSKI, Wien (AT); CLEVER CONTOUR GESMBH, Leoben (AT)

(72) Inventor: Franz STEINER, Kierling Klosterneuburg (AT)

(73) Assignees: Rudolf STONAWSKI, Wien (AT); CLEVER CONTOUR GESMBH, Leoben (AT)

(21) Appl. No.: 15/532,163

(22) PCT Filed: Dec. 2, 2015
(86) PCT No.: PCT/AT2015/050307

§ 371 Date: Jun. 1, 2017

(30) Foreign Application Priority Data
Dec. 2, 2014 (AT) A 50875/2014

(51) Int. Cl. B29C 53/08; B21D 7/02

(52) U.S. Cl. CPC B29C 53/083; B21D 7/02; B29K 2101/12

(57) ABSTRACT

The invention relates to a device (1) for bending a profiled workpiece (2), comprising a movably mounted, drivable bending tool (3) and a holder (4) for the profiled workpiece (2), the holder (4) having a profiled channel (29) for the profiled workpiece (2), on the outlet side (5) of which is formed a counter-tool (5′) for the profiled workpiece (2) when the latter is bent, wherein the bending tool (3) can be driven relative to said counter-tool (5′).

The invention relates to a device for bending a profiled workpiece, comprising a drivable bending tool and a holder for the profiled workpiece, the holder having a passage for the profiled workpiece, the cross-section of the passage being adapted to the profile of the profiled workpiece, wherein the bending tool can be driven relative to said holder.

In many fields of application there is a need of individually adaptable, elongated profile elements which can be used as strand or spacer elements in skeletal or grid-like structures.

For example, the WO 2011/044595 A1 proposes a novel support device for adapting to a body part, which is to replace conventional plaster casts. In this known technology, image data from the respective body part are recorded and evaluated, using computing means, in order to determine a 3-D model. On the basis of this 3-D model, a set of control signals for different driver stages is generated via a numerical control. Said driver stages control all sorts of shaping means via respective drive signals. Starting from a suitable bar or strand material made of thermoplastic plastic, elongated supporting elements are produced with the aid of the various shaping means. Having been heated with the aid of a heating device, the rod material is supplied to a shaping device comprising shaping rolls. In addition, a pressure adjustment unit is provided for an upper shaping roll to move the latter with the respective pressure and also with the respective adjustment relative to two lower shaping rolls and thus to provide corresponding curvatures, bends, indentations or the like in the strand material.

However, protective devices, such as elbow protectors, safety helmets, protective clothing for workers and sportspeople may also be produced from the individually adapted supporting elements. Thus, for example, a design of protective trousers is described, in which in a textile fabric anatomically individually formed protective parts are inserted in the body areas to be protected. Of course, other applications are possible for this method, such as anatomically shaped vehicle seats,

In addition, from DE 10 2004 002 539 A1 a method and a device for bending an elongated profile body, in particular a tube made of plastic that can be deformed under increased temperature have become known. The profile body is supplied in the axial direction to a heating device for heating the portions to be bent of the profile body. The heated bending portions are bent by means of a bending device. Bending rolls are provided for bending, wherein the last bending roll unit in the feed direction can be varied in terms of its position. Finally, the bent portions of the profile body are cooled and the profile body is cut to the respective length. The machining operations can be controlled by means of a control device, Starting from this roll bending, the EP 2 674 279 A1 discloses a roll bending technology which can be used for extruded profiled workpieces,

In practice, however, such roll bending has shown numerous disadvantages. The control of the bending rolls is relatively complicated. In addition, limitations occur in the cross-section geometry of the profile body. Furthermore, it is disadvantageous that the bending rolls cannot be exchanged or only at great expense, for bending other profile bodies. In addition, the space requirement of the bending rolls is disadvantageous.

The DE 10 2006 029 637 A1 discloses a device for bending cylindrical workpieces, in which a bending device is rotatably provided on a base. A chuck is provided spaced apart from the bending device which chuck, however, is only intended for holding workpieces but not as a counter-tool for bending.

It is an object of the invention to reduce or eliminate the disadvantages of the prior art. Therefore, a particular object of the invention is to provide an efficient, versatile, nevertheless constructionally simple bending device of the above described type, by means of which profile elements having different cross-section geometries can be bent easily and in many different ways,

Said object is solved by a device as stated in claim 1. Advantageous embodiments and further improvements are defined in the depending patent claims.

Thus in the device according to the preamble it is, according to the invention, in particular provided that on the outlet side of the passage of the holder a counter-tool for the profiled workpiece is formed when the latter is bent, and that the bending tool is mounted by an articulated arm structure so as to be able to rotate about several axes.

Elongated or oblong profiled workpieces can be bent in a particularly simple manner with the bending device according to the invention, wherein a broad range of geometries may be generated by the bending tool, preferably in the form of a bending mandrel. For this purpose, a bar or strand material forming the profiled workpiece is provided, which may be selected e.g. from the materials cited in the AT 507 888 B1 according to the intended application. Therefore, the bar or strand material provided may preferably be thermoplastic plastics, however, also metals, metal alloys or memory materials having a shape memory as well as also plastics with (metal) reinforcements. The profiled workpieces may have a variety of cross-section geometries, for example, a round or a rectangular cross-section, the cross-section of the profiled workpieces being preferably invariable in the longitudinal direction of the profiled workpiece. The semi-finished product for the workpieces is preferably obtained by means of extrusion. The respective profiled workpiece is guided through the outlet opening of the profile passage of the holder, which is preferably formed in accordance with the cross-section of profiled workpiece.

In a preferred embodiment, the holder is mounted in a stationary, i. e. fixed manner in the bending process. However, the holder may also be adjustably, in particular displaceably mounted and/or twistably mounted—for instance, about a pivot axis coinciding with the feed direction of the profiled workpiece. The outlet opening may also be provided on a front or inner bearing part of the holder, wherein the front or inner bearing part may be adjustably mounted on or in an outer bearing part or housing of the holder. The particular advantage of this is that the front or inner bearing parts may be adapted as insert element which can be replaced depending on the application. On the other hand, in many cases it is also advantageous in bending, if the holder or, in particular, its separate front or inner bearing part is mounted adjustably, in particular twistably and/or longitudinally displaceably. For example, the bearing parts may be accommodated in a housing of the holder.

The holder or, if available, its inner bearing part or front bearing part is formed with a relatively small cross-section at least in the region of the outlet opening, whereby the strength for the bending operations is guaranteed, and whereby, with such a narrow design, also narrow bending radii can be achieved on the outlet side of the front side of the holder or bearing part. In particular in the case of bending of heated thermoplastic plastics, in general thin material cross-sections of the tube-shaped holder or bearing part, which in principle is preferably essentially tubular shaped, suffice so that the profiled workpieces can be bent over closely, by virtually 180°.

Of course, the holder or its bearing part, if such is provided, may basically be mounted in a stationary manner, without the possibility of adjustment, such as displacing or twisting, wherein moreover, in the case of relatively smaller dimensions any especially stable arrangements can be ensured in a simple manner.

As briefly pointed out in the above, the holder can simply be tubular, thus allowing for a very efficient construction. The tubular shape does not need to have an identical diameter or identical cross-section over the entire length of the holder, but can also have different diameters or cross-sections, for example, to be able to accommodate other units, such as will be illustrated in more detail below.

The present bending device is particularly suited for bending extruded sections, that is extrusion profiles that are machined in one line comprising an extruder with extrusion tool as well as the bending device. It can also be envisaged to additionally bend the profiled workpieces after the extrusion with sufficient heat and thus plasticity, but usually it is often advantageous for the most part to (re-)heat the profiled workpiece prior to bending; accordingly, the holder preferably comprises a heating device, wherein said heating device can be mounted e.g. outside on the holder or also preferably inside in the holder. For example, the heating device may be available in the form of an electric heating coil, but any other type of heating may also be provided, such as an infrared heat radiator, warm air supply, a heating mat, in particular a contact heating, but also in general radiant heaters such as halogen heaters, quartz radiators, etc. The heating device does not have to be present coherently, continuously in the path of the profiled workpieces, but can also be formed as discrete heating elements, with discrete interspaces. Furthermore, the workpieces do not have to remain in the area of the heating device, but can be guided continuously, where appropriate, at reduced speed, through the region equipped with the heating device. On the other hand, it is also possible to move the heating device and, where appropriate, keep the workpiece stationary.

In the case of accommodating the heating device in the interior of the holder it is favorable for optimal utilization of space if the heating device is mounted on the wall of the passage of the holder.

To fix that part of the profiled workpiece that is still present in the inside of the holder during bending, it is of further advantage if a locking device for the profiled workpiece is associated with the holder.

Similarly, if feeding from the extruder is not sufficient, a workpiece feed device, for example, with clamp rolls, can be allocated to the holder.

For additionally increasing the flexibility during bending of the workpieces it is also advantageous if the holder or a separate front or inner bearing part thereof is mounted adjustably, e.g. twistably and/or longitudinally displaceably.

Similar to the heating device, the passage of the holder can be discontinuous, but, for reasons of proper support and guidance of the profiled workpiece, it can also be formed by a continuously extending profiled channel.

The bending tool can be formed like a bending mandrel, but in particular it can comprise at least a workpiece gripping element to seize the profiled workpieces to be bent in positive engagement and thus achieve a directed bending in a simple manner. To seize the respective profiled workpiece in the desired orientation, the workpiece gripping element can also be movably mounted in the area of the bending tool.

For the purpose of adapting to the profiled workpieces of different dimensions and profiles it is also of advantage if the gripping element is detachably mounted. Thereby, the gripping element or the gripping elements can be replaced by another, customized gripping element, for example in the case of different profiled workpieces to be bent.

For constructional reasons as well as with respect to the desired movements of the bending tool during bending, the bending tool may also be mounted in a separate bearing head or bending head, preferably in a twistable manner.

Depending on the desired bending operations, the bending tool could also be moved merely in a translatory way, if necessary, with a rotation about its own axis, whenever profiled workpieces are to be bent. To also enable other movements in space, for obtaining a spatial bending (3D bending) it is favorable if the bending tool is supported by a rotary plate base.

Here, it is of further advantage if the rotary plate base supports the bending tool by pivotally interconnected articulated arms. Moreover, it is favorable if one of the articulated arms is twistably mounted on the rotary plate base.

It has been shown that a thermoplastic plastic can expand by a type of swelling, especially if it is heated in the area of the holder shortly before bending. Consequently, it may be that the outlet of the holder, that is to say its dimensioning in a transverse direction, no longer optimally fits the cross-sectional dimensions of the profiled workpieces. To remedy this, the outlet may have a mouth, for example in the form of an iris diaphragm, that is easily adaptable to a cross-sectional change of the profiled workpiece.

Below, the present invention will be described in more detail with reference to preferred embodiments illustrated in the drawing, in which:

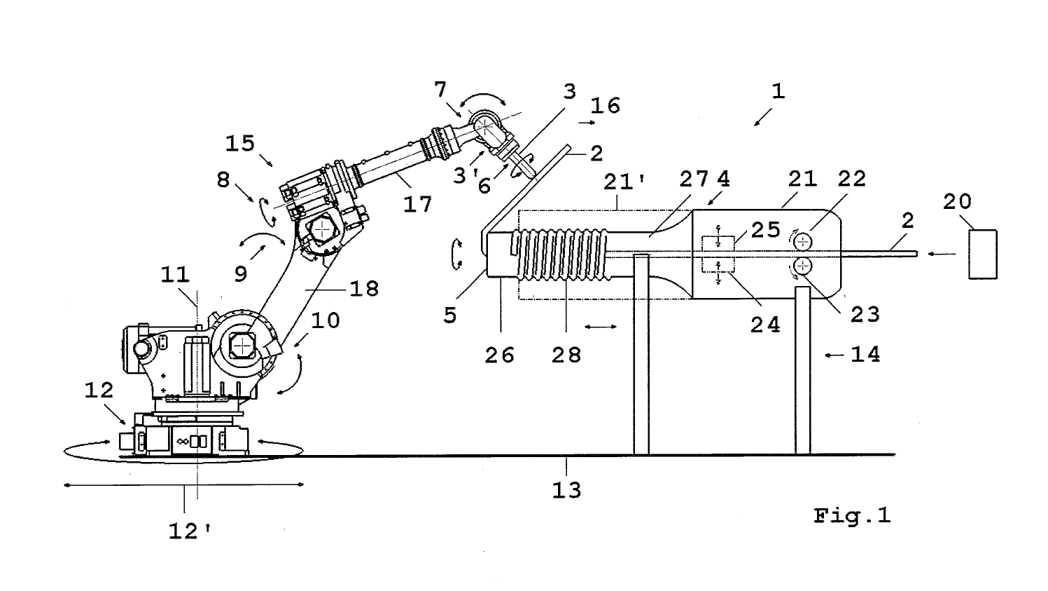

FIG. 1 shows a side view of a device for bending profiled workpieces;

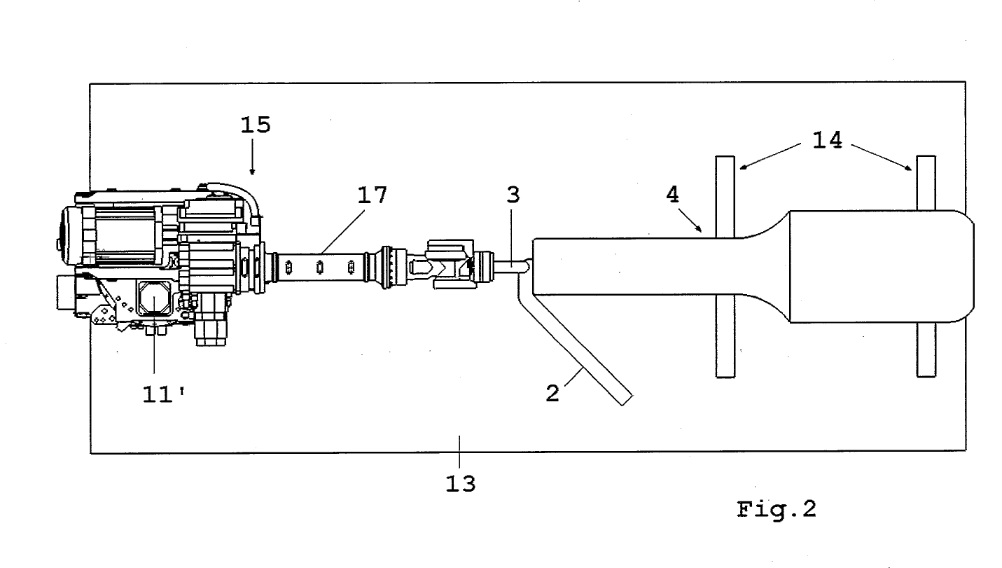

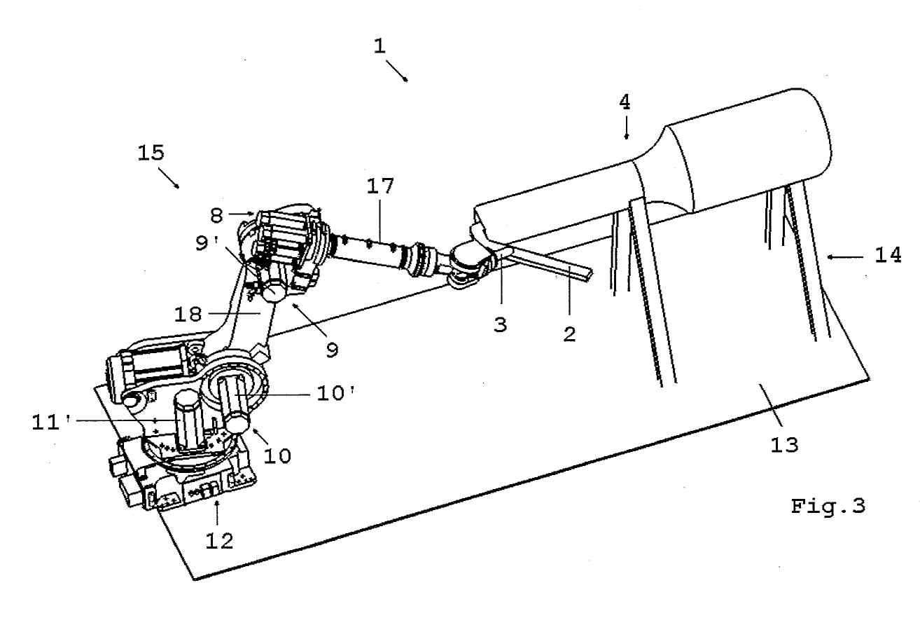

FIGS. 2 and 3 show a top view (FIG. 2) and a diagrammatic view (FIG. 3), respectively, of this device for bending profiled workpieces;

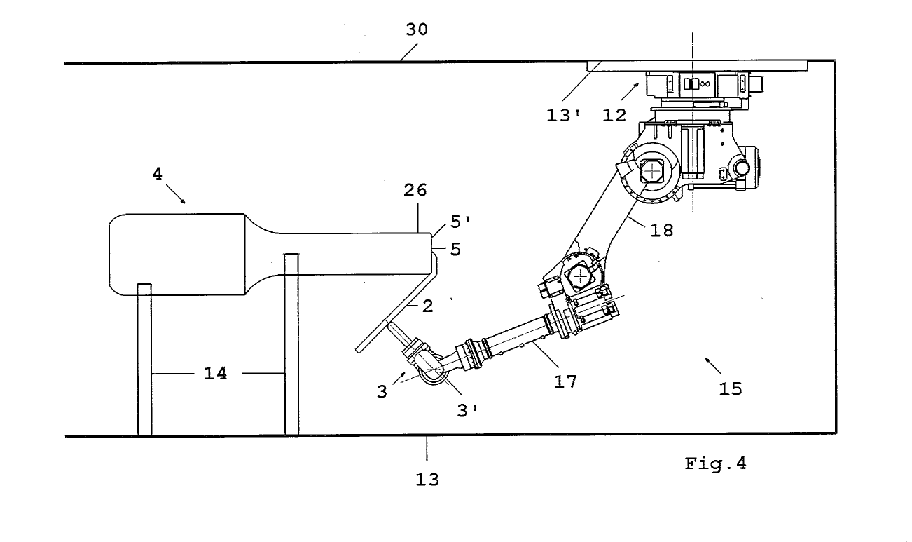

FIG. 4 shows a corresponding device for bending profiled workpieces, however, now with an “overhead arrangement” of the bending tool;

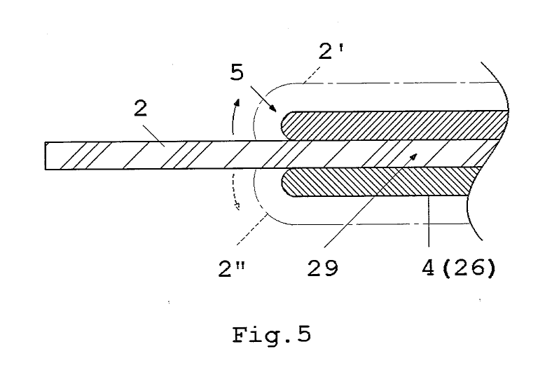

FIG. 5 shows a schematic longitudinal section through the front part of a holder of a bending device according to FIGS. 1 to 4 including a front portion of a profiled workpiece, wherein its bending options, in particular by 180° rearwards, are indicated by dot-dash lines;

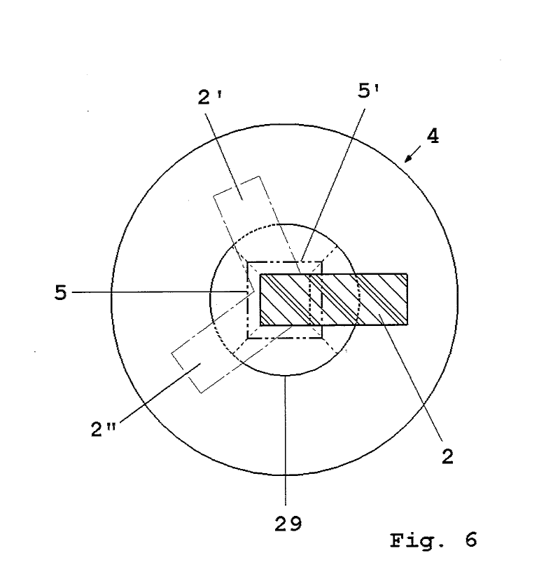

FIG. 6 shows a schematic front view of a holder of the present bending device, comprising the outlet opening for the profiled workpieces and, as an example, a profiled workpiece having a rectangular (or square) cross-section;

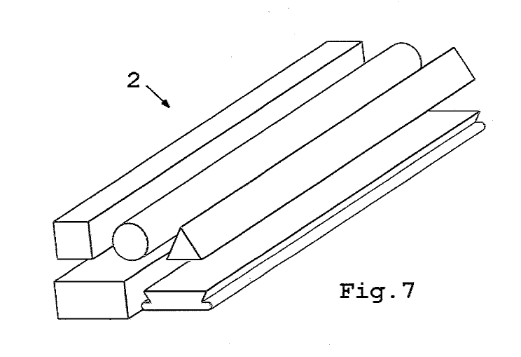

FIG. 7 shows diagrammatic views of several possible profiled workpieces;

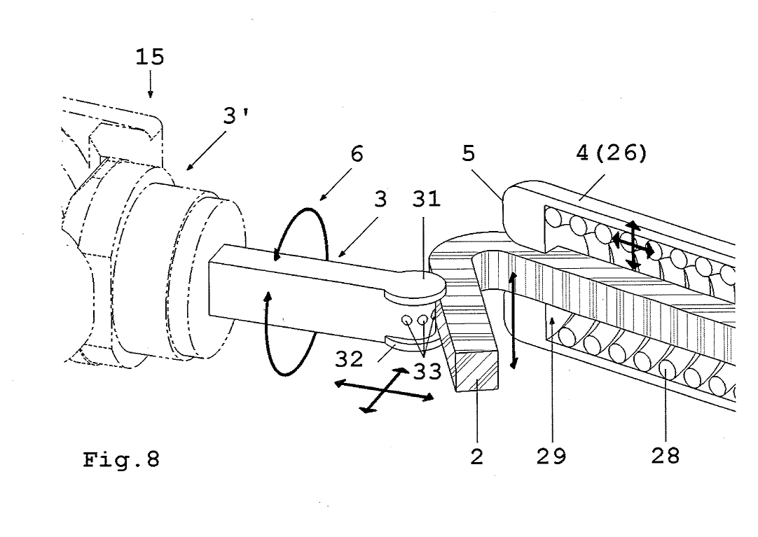

FIG. 8 shows, in a diagrammatic partial view, the bending of the profiled workpiece with the help of a bending tool comprising holding flanges on the bending mandrel for seizing the profiled workpiece, the front part of the holder being illustrated in a longitudinal section, for the purpose of illustrating a heating device;

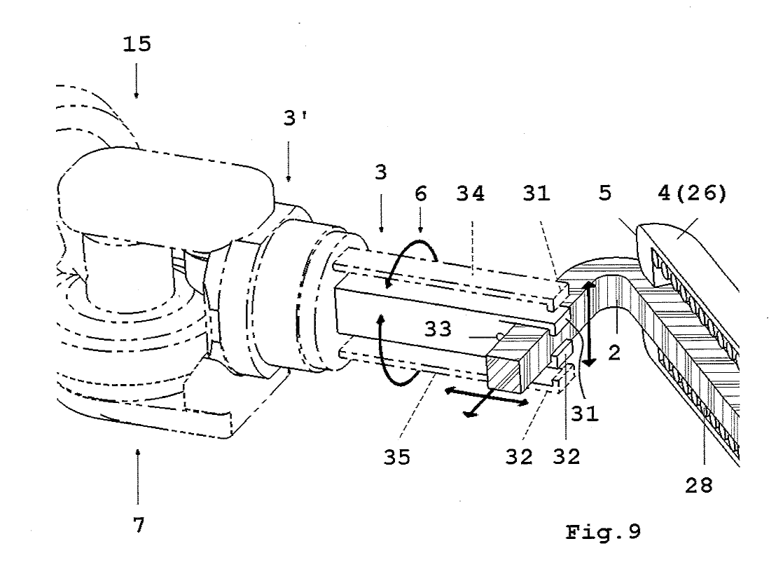

FIG. 9 shows an illustration, which is similar to the one in FIG. 8, of the bending tool shown by dot-dash lines, here with gripping elements that are adjustable against one another; and

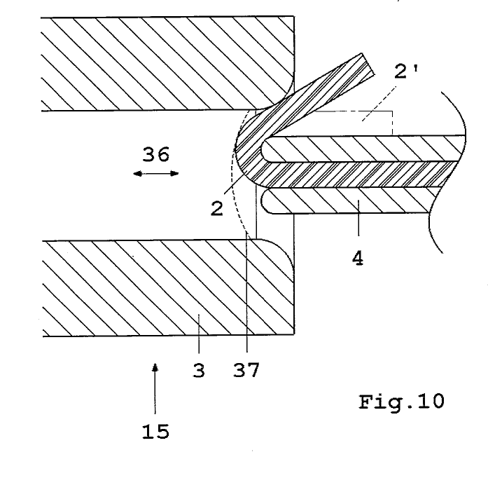

FIG. 10 shows a schematic sectional view, which is similar to the one in FIG. 5, of the bending of the profiled workpiece having a linearly moved, hollow bending mandrel.

FIG. 1 shows a device 1 for bending profiled workpieces 2, for example made of plastic, in particular thermoplastic material, or also made of metal; said device 1 is essentially composed of two main components, that is, on the one hand, a movable bending tool 3 that engages on the respective profiled workpiece 2 for bending the same, as can be seen from FIG. 1, and, on the other hand, a holder 4 which is preferably mounted in a stationary manner at least during the bending and forms, with an outlet area or front side 5, a counter-tool when bending the profiled workpieces 2, as may also be directly seen from FIG. 1, where the workpiece 2 is shown while being bent upwardly and backwardly by means of the bending tool 3.

The actual bending tool 3 is rotatable or pivotable about e.g. a total of six axes 6, 7, 8, 9, 10 and 11, as indicated by corresponding double arrows 6 to 11 in FIG. 1. The movements of the bending tool 3 about the axes 6 to 11 can be controlled in correspondence to the desired bending operation, in particular with the aid of a computer or a CNC program control or a similar unit, which is not specifically illustrated in the drawing; in any case, such a control can easily be configured by a person skilled in the art, so that no further illustration thereof is required. It would also be conceivable to manually control the drives required for the individual rotational movements or pivotal movements about the axes 6 to 11 via a control console (not shown in more detail in the drawing).

According to FIG. 1 the entire bending unit 15 comprising the bending tool 3 is mounted on a foundation 13—e.g. in a stationary or linearly displaceable manner, cf. arrow 12′—via a rotary plate base 12, on which foundation 13 also the holder 4 is fixed by means of a mount 14. During the bending of the profiled workpieces 2 a fixed relation between the bending unit 15 and the holder 4 including the mount 14 is given. For the bending operation itself, of course, it is the bending tool 3 that is moved or driven depending on the bending to be performed, wherein in particular also translatory movements are possible when the workpieces 2 are bent backwards, which is schematically indicated in FIG. 1 at 16, apart from corresponding pivotal movements and combined pivotal and pushing movements.

Moreover, FIG. 3 shows respective pivot drives for the pivotal or rotational movements about the axes 9, 10 and 11 (cf. FIG. 1), in the form of e.g. electric, hydraulic or alternatively pneumatic motors 9′, 10′, 11′. Corresponding drives are provided for the movements about the axes 6, 7 and 8, even if this is not emphasized in particular in the drawing.

In FIGS. 1, 2, and 3, by way of example different bending operations are illustrated, including bending of the workpieces 2 in different directions rearwards, relative to the holder 4, wherein it can be seen that the bending tool 3, which is preferably formed like a mandrel, engages on the respective workpiece 2 and thus presses the workpiece 2 in the desired direction, e.g. upwards and rewards, as according to FIG. 1, or to the side, as according to FIG. 2 and also according to FIG. 3. FIGS. 8 and 9 show examples of the design of bending tools 3, which will be explained in more detail below.

To obtain this bending movement of the bending tool 3, in the shown embodiment, the bending unit 15 comprises an articulated arm structure having two articulated arms 17, 18 which are connected to each other by an articulated joint (cf. axes 8 and 9) and furthermore, on the one hand, pivotally fixed on the rotary plate base 12 (cf. axes 10 and 11) and, on the other hand, pivotally (axis 7) support a bending or bearing head 3′ with the rotatable (cf. axis 6) bending tool 3.

FIG. 1, on the right, merely schematically shows that the respective profiled workpiece 2 on the side of the holder 4 facing away from the bending unit 15 is supplied to the rear side thereof, for example by means of an extruder 20 (only schematically shown), with the aid of which the workpieces 2 are extruded in the soft condition in the usual manner and are thereby pushed forwards upon solidifying on the exit of the extrusion tool.

FIG. 1 also shows only schematically, for example, inside a rear part of the holder 4, inside a housing 21, that for feeding the profiled workpieces 2 a workpiece feed device 22, e.g. with feed rolls 23 as well as furthermore a locking device 24, for example with clamp jaws 25 can be allocated to the holder 4. The drive directions (rotational directions) of the rolls 23 or the vertical adjustment direction of the clamp jaws 25 are schematically shown with arrows in FIG. 1. Corresponding drives, for example with the help of pneumatic or hydraulic motors, where appropriate, also electric motors, are known to the person skilled in the art and do not require any further explanation. In addition to or instead of the feed device 22, it may also be provided to seize the workpiece 2 with the help of gripping elements of the bending tool 3 and to pull it out of the holder 4 and to bend it then.

Furthermore, the holder 4 can comprise a front, hollow bearing part 26 with a relatively small overall cross-section, to obtain the narrowest possible bending radii for the workpieces 2 on the outlet side 5, wherein the bearing part 26 is provided for example as a separate part, for instance, as a replacement or exchange part and may be connected to the hollow rear housing part 21 approximately in the area of a narrowing 27 according to FIG. 1. The front bearing part 26 may also be rotatable about the longitudinal axis, in accordance with the feed axis of the profiled workpieces 2, and in addition an axial displaceability for the bearing part 26 relative to the rear housing part 21 may be given by means of corresponding slide bearings or roller bearings for the bearing part 26 in the housing 21 which, however, is not shown in more detail in the drawing; in any case, cf. the double arrow in the area below the bearing part 26 in FIG. 1.

On the other hand, as is schematically indicated by dot-dashed lines 21′ in FIG. 1, the housing may also be prolonged a good way forward, toward the outlet side 5. In addition, FIG. 1 schematically shows a heating device 28 outside on the bearing part 26, which for example is formed by an electric heating coil. Such an outer heating device 28 is conceivable if the wall of the bearing part 26 is formed in a particularly thin and, moreover, best possible heat-conductive manner. Otherwise, usually the heating device 28, as is in particular also shown in FIGS. 8 and 9, is mounted in the interior of the holder 4 or the bearing part 26, so as to be able to hold the profiled workpieces 2 at the desired temperature for the bending deformation as directly as possible. Other embodiments such as IR radiators (infrared radiators), fan heaters, heating mats, halogen heaters, quartz radiators, etc. may also be used as heating device 28, and they may extend over shorter or longer distances. The respective workpiece 2 does not necessarily have to stop at the heating device 28 for heating, it may also be heated when being moved past.

Furthermore, a profiled channel for the profiled workpiece provided in the holder 4 or the bearing part 26 is designated with 29 in FIG. 8. The 320 schematic sectional view according to FIG. 5 also shows this profiled channel 29 as passage 29 in the interior of the holder 4 or its bearing part 26, the profiled workpiece 2 pushed forward through this channel 29 being shown prior to being bent (in full lines) as well as after being bent upwards—cf. the bent workpiece 2′—or downwards—cf. the workpiece 2″; cf. also FIG. 6. In 325 contrast to the shown example, the channel 29 does not necessarily extend with a continuous wall through the holder 4.

It also follows from FIG. 6 that the opening (mouth) of the channel 29 on the outlet side 5 may vary—depending on the temperature, also see the dot-dashed line 5′ of the larger square in FIG. 6.

In FIG. 4 a modification of the device 15 according to FIGS. 1 to 3 is shown in so far as the actual bending unit 15 is connected, for example, to a ceiling 30 by means of a rotary plate base 12; whereas the holder 4 in turn is attached again on a foundation 13 by means of a mount 14. In other respects, the bending unit 15 according to FIG. 4 corresponds to that according to FIGS. 1 to 3 in terms of its detailed construction, wherein, in particular, the bending tool 3 in turn is rotatably mounted in a bearing head 3′ (i.e. about the axis 6 in FIG. 1). The outlet side 5 of the holder 4 or possibly of its bearing part 26 in turn again forms the counter-tool 5′ when the profiled workpieces 2 are bent, whereby these workpieces 2, as may also be clearly seen from FIGS. 1, 2 and 4, can be bent about the edge or the brim of the outlet side 5. On the other hand, the bending unit 15 in turn may provide movements (about six axes 6 to 11), as according to FIGS. 1 to 3, for the bending tool 3.

FIG. 7 shows examples of five different profiled workpieces 2, with most varied profiles, for better understanding, whereby the workpieces may have a square profile, a circular profile, triangular profile, a rectangular profile or a dovetail profile as well as any other cross-sectional profile, for instance. Of course, other complicated profiles, for example, elliptic, hexagonal, with grooves, hollow, tubular, etc. are also conceivable.

The mandrel-like bending tool 3 shown in FIG. 8, which is rotatably supported and driven in the bearing head 3′ (cf. double arrow 6 in FIG. 8) has, on its front end coming into contact with the profiled workpiece 2 for bending, two flange-like broadened gripping elements 31, 32, the distance of which matches the thickness of the workpiece 2 to be bent; thus, the bending tool 3 can better seize the workpiece 2 during bending and subject it to the deformation given by the corresponding movement of the bending tool 3 (cf. also the arrows in FIG. 8). In addition, one or several openings 33 are provided at the rounded front end of the bending tool 3 in order to supply a cooling medium, e.g. cooling air, to the workpiece 2 for cooling the latter. In addition, in FIG. 8 it is indicated by arrows that the heating device 28 may be movable relative to the holder 4 in a longitudinal and/or transverse manner.

Similarly, the bending tool according to FIG. 9 is designed with gripping elements 31, 32, here in the form of hook-like projections on plate-shaped extensions of the bending tool mandrel 3, resulting in a grip opening—the cross-section of which matches the cross-section of the profiled workpiece 2 (for example, square in this case)—between the inner front side (not shown in detail) of the bending tool 3 and the outer hook-like gripping elements 31, 32. The dot-dashed lines show a changed design and position (open position) of the bending tool 3, with two separate tongue-like projections 34, 35, for 370 example, to be able to bend workpieces 3 with larger cross-sections. It is of particular advantage if different interchangeable bending tools 3 can be used in one and the same bending unit 15, in particular possibly also in one and the same bearing head 3′.

Moreover, the bending unit 15 according to FIGS. 8 and 9 has already been described in more detail above, in connection with the holder 4 and the workpiece 2, so that no further description is necessary. Another thing worth mentioning is that also in the device according to FIG. 9 cooling air openings, for example 33, may be present.

In any case, in both bending units 15 according to FIGS. 8 and 9 it is of importance that the front end of the bending tool 3 can be moved back and forth, to the left and to the right, up and down according to the different double arrows, as well as be twisted in both rotational directions according to double arrow 6. This results in an extremely high versatility in connection with the bending of the profiled workpieces 2, whereby the described movements can be obtained by correspondingly triggering the drives allocated to the individual axes 6 to 11.

FIG. 10 shows, in a schematically longitudinal section, an essentially simplified embodiment of the bending unit 15, comprising a hollow bending tool 3. In this simplified embodiment, the bending tool 3 is only linearly moved to and fro only according to the double arrow 36, to bend the profiled workpiece 2 back in itself, cf. also the position 2′ in FIG. 10. Such a simplified embodiment, with a simplified movement upon bending, is particularly expedient when it comes to bending a large number of workpieces in the manner shown, the investment of an individual bending tool mandrel 3 with dimensions adapted to the holder 4 or the workpiece 2 paying off; for other workpiece dimensions other bending tool mandrels 3 would be required, in which case these bending tool mandrels 3 can be provided in particular as exchangeable inserts on a bending tool carrier (not shown in FIG. 10), in principle in a manner similar to the exchangeable bending tool mandrels 3 with attachment in one and the same bearing head.

Furthermore, in FIG. 10, a dashed line indicates an inner forming area or bending area 37, to be able to laterally bend away the workpieces 2 with this bending area 37, above all initially, from its feeding direction, that is its longitudinal axis direction.

1-18. (canceled)

19. A device (1) for bending a profiled workpiece (2), comprising a drivable bending tool (3) and a holder (4) for the profiled workpiece (2), the holder (4) having a passage (29) for the profiled workpiece (2) the cross-section of which is adapted to the section of the profiled workpiece (2), wherein the bending tool (3) can be driven relative to said holder (4) and, on the outlet side (5) of the passage (29) of the holder (4), a counter-tool (5′) for the profiled workpiece (2) is formed when the latter is bent, wherein the holder (4) is designed tubular and wherein the bending tool (3) is mounted on an articulated arm structure (17, 18) for rotation about several axes (6 to 11).

20. The device (1) according to claim 19, wherein the tubular holder (4) comprises a heating device (28) for the profiled workpiece (2).

21. The device (1) according to claim 20, wherein the heating device (28) is mounted on the wall of the passage (29) of the tubular holder (4).

22. The device (1) according to claim 19, wherein a locking device (24) for the profiled workpiece (2) is allocated to the holder (4)

23. The device (1) according to claim 19, wherein a workpiece feed device (22) is allocated to the holder (4).

24. The device (1) according to claim 19, wherein a holder (4) or a separate front or inner bearing part (26) of the same is mounted adjustably, for example, rotatably and/or longitudinally displaceably.

25. The device (1) according to claim 19, wherein the passage (29) is formed by a continuously extending profiled channel.

26. The device (1) according to claim 19, wherein the bending tool (3) comprises at least one workpiece gripping element (31, 32).

27. The device (1) according to claim 26, wherein the'workpiece gripping element (31, 32) is movably mounted.

28. The device (1) according to claim 26, wherein the gripping element (31, 32) is detachably mounted.

29. The device (1) according to claim 19, wherein the bending tool (3) is formed like a mandrel.

30. The device (1) according to claim 19, wherein the bending tool (3) is mounted in an at least linearly movably arranged, drivable bearing head (3′).

31. The device (1) according to claim 30, wherein the bending tool (3) is rotatably mounted in the bearing head (3′).

32. The device (1) according to claim 19, wherein the bending tool (3) is supported by a rotary plate base (12).

33. The device (1) according to claim 32, wherein the rotary plate base (12) supports the bending tool (3) by pivotally interconnected articulated arms (17, 18).

34. The device (1) according to claim 33, wherein one of the articulated arms (17, 18) is rotatably mounted on the rotary plate base (12).

35. The device (1) according to claim 19, wherein the passage (29) comprises a mouth, for example, in the form of an iris diaphragm that is adaptable to cross-sectional changes of the profiled workpiece (2).
